(19) United States
(12) Patent Application Publication
(10) Pub. No.: US 2022/0040980 A1
(43) Pub. Date: Feb. 10, 2022

(54) METHOD FOR CLEANING INK DISCHARGER OF INKJET HEAD

(71) Applicant: Konica Minolta, Inc., Tokyo (JP)

(72) Inventors: Junji UJIHARA, Tokyo (JP); Yasuharu SAITA, Tokyo (JP)

(21) Appl. No.: 17/388,429

(22) Filed: Jul. 29, 2021

(30) Foreign Application Priority Data
Aug. 7, 2020 (JP) 2020-135239

(51) Int. Cl. B41J 2/165

(52) U.S. Cl. CPC B41J 2/16517

(57) ABSTRACT

There is provided a method for cleaning an ink discharger of an inkjet head, and the method includes causing dry ice particles to collide with an ink discharge port of an inkjet head.

The entire disclosure of Japanese patent Application No. 2020-135239, filed on Aug. 7, 2020, is incorporated herein by reference in its entirety.

### BACKGROUND

### Technological Field

The present invention relates to a method for cleaning an ink discharger of an inkjet head.

### Description of the Related Art

Conventionally, an inkjet head used in an industrial printing machine needs to discharge ink for a long time in order to perform mass production of printed matters.

Ink or varnish used in the industrial printing machine has a higher viscosity than ink used in a printer, and is easily retained in a flow path inside the inkjet head or inside the ink discharger. In addition, the ink or the varnish contains a large solid content. Therefore, particularly when the ink or the varnish is discharged for a long time, the solid content precipitated by the retention is easily attached to the ink discharger. In addition, clogging of the ink discharger of the ink-jet head easily occurs due to the precipitated and fixed solid content. The clogging causes color unevenness and density unevenness of an image due to a defective nozzle (ink or varnish cannot be discharged from a nozzle), color mixing caused by a decrease in landing position accuracy due to flight bending of droplets of ink or varnish, and the like disadvantageously. In particular, discharge failure due to the retention easily occurs.

As a means for eliminating clogging of the ink discharger, there is a method for discharging ink or varnish idly (a method for discharging ink or varnish at the time of non-printing). However, idle discharge takes time, consumes ink or varnish, and has low attached matter removal efficiency disadvantageously.

There are various methods for cleaning the ink discharger of the inkjet head.

For example, JP 2011-16088 A and JP 2011-16089 A each disclose a coating device that discharges a solution by an inkjet method. According to JP 2011-16088 A and JP 2011-16089 A, a wiping unit included in the coating device wipes a discharge surface of a nozzle, and good wipeability can be maintained.

JP 2014-168911 A discloses an inkjet recording device including a cleaning liquid that wets an ink composition and a wiping member that wipes a surface of a nozzle plate. According to JP 2014-168911 A, a cleaning property of the nozzle plate and a liquid-repellent film storage property are improved by the cleaning liquid and the wiping member.

As disclosed in JP 2011-16088 A, JP 2011-16089 A, and JP 2014-168911 A, a method for cleaning an ink discharger of an inkjet head is known.

However, according to findings of the present inventors, by simply wiping an ink discharger with a wiping member as disclosed in JP 2011-16088 A, JP 2011-16089 A, and JP 2014-168911 A, generation of a defective nozzle and a decrease in ink landing position accuracy are not solved.

### SUMMARY

The present invention has been achieved in view of the above circumstances, and an object of the present invention is to provide a method for cleaning an ink discharger of an inkjet head, capable of eliminating generation of a defective nozzle in the inkjet head and a decrease in ink landing position accuracy.

To achieve the abovementioned object, according to an aspect of the present invention, a method for cleaning an ink discharger of an inkjet head, reflecting one aspect of the present invention comprises: causing dry ice particles to collide with an ink discharge port of an inkjet head.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a flowchart of a method for cleaning an ink discharger of an inkjet head according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

[Inkjet Head]

An inkjet head used in the present invention may be either an on-demand type inkjet head or a continuous type inkjet head. Examples of the on-demand type discharge head include an electromechanical conversion type including a single cavity type, a double cavity type, a bender type, a piston type, a share mode type, and a shared wall type, and an electrothermal conversion type including a thermal inkjet type and a bubble jet (bubble jet is a registered trademark of Canon Inc.) type.

A liquid-repellent film may be formed on a surface of a nozzle plate of the inkjet head. Examples of the liquid-repellent film include a fluorine-based resin and a silicone resin. Examples of the fluorine-based resin include a fluorine-based polyimide and a fluorine-based polyamideimide. A fluorine-based polyimide is preferably used from a viewpoint of durability.

The thickness of the liquid-repellent film is preferably 1 μm or more and 10 μm or less, and more preferably 3 μm or more and 8 μm or less. When the thickness is 1 μm or more, irregularities on a surface of the nozzle plate can be filled with the liquid-repellent film. When the thickness is 10 μm or less, processing accuracy of an ink discharge port can be secured, and cost can be suppressed. When the thickness of the liquid-repellent film is within the above range, the liquid-repellent film is less likely to be damaged.

[Inkjet Ink]

An ink remaining inside the inkjet head and in the ink discharger is not particularly limited, and examples of the ink include an active ray curable ink, a water-based ink, and a solvent-based ink. In particular, when the active ray curable ink is used, a solid matter precipitated from the ink is likely to be firmly attached. Therefore, the effect of the cleaning method according to an embodiment of the present invention is remarkable. Furthermore, when an ink containing a wax is used, the wax is easily fixed to the vicinity of a nozzle surface, and therefore the effect of the cleaning method according to an embodiment of the present invention is remarkable.

The active ray curable ink contains an active ray polymerizable compound and an active ray polymerization initiator.

Examples of the active ray polymerizable compound include a radically polymerizable compound and a cationically polymerizable compound. The active ray polymerizable compound is crosslinked or polymerized by being irradiated with an active ray to cure an inkjet ink. The active ray polymerizable compound may be a monomer, a polymerizable oligomer, a prepolymer, or a mixture thereof. Only one kind or two or more kinds of the active ray polymerizable compounds may be contained in the inkjet ink.

Examples of the active ray include an ultraviolet ray, an electron beam, an α ray, a γ ray, and an X-ray.

The radically polymerizable compound is a compound having a radically polymerizable ethylenically unsaturated bond (a monomer, an oligomer, a polymer, or a mixture thereof). The radically polymerizable compound may be used singly or in combination of two or more kinds thereof.

Examples of the compound having a radically polymerizable ethylenically unsaturated bond include an unsaturated carboxylic acid and a salt thereof, an unsaturated carboxylate compound, an unsaturated carboxylic acid urethane compound, an unsaturated carboxylic acid amide compound and an anhydride thereof, acrylonitrile, styrene, unsaturated polyester, unsaturated polyether, unsaturated polyamide, and unsaturated urethane. Examples of the unsaturated carboxylic acid include (meth)acrylic acid, itaconic acid, crotonic acid, isocrotonic acid, and maleic acid.

The radically polymerizable compound is preferably an unsaturated carboxylate compound, and more preferably a (meth)acrylate. Note that here, “(meth)acrylate” means acrylate or methacrylate, and “(meth)acrylic” means acrylic or methacrylic.

Examples of a monofunctional (meth)acrylate include isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethyl hexahydrophthalic acid, butoxyethyl (meth)acrylate, ethoxydiethylene glycol (meth)acrylate, methoxydiethylene glycol (meth)acrylate, methoxypolyethylene glycol (meth)acrylate, meth oxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethyl succinic acid, 2-(meth)acryloyloxyethyl phthalic acid, 2-(meth)acryloyloxyethyl-2-hydroxyethyl-phthalic acid, and t-butylcyclohexyl (meth)acrylate.

Examples of a polyfunctional (meth)acrylate include: a bifunctional (meth)acrylate such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, PO adduct of bisphenol A di(meth)acrylate, by hydroxypivalate neopentyl glycol di(meth)acrylate, polytetramethylene glycol di(meth)acrylate, polyethylene glycol diacrylate, or tripropylene glycol diacrylate; and a tri- or higher functional (meth)acrylate such as trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerine propoxy tri(meth)acrylate, or pentaerythritol ethoxy tetra(meth)acrylate.

The radically polymerizable compound preferably contains a (meth)acrylate modified with ethylene oxide or propylene oxide (hereinafter, also simply referred to as a “modified (meth)acrylate”). The modified (meth)acrylate is more photosensitive. In addition, the modified (meth)acrylate is likely to be more compatible with another component even at a high temperature. Furthermore, the modified (meth)acrylate is less likely to cause curing shrinkage, and therefore is less likely to cause curling of a printed matter at the time of irradiation with an active ray.

Examples of the cationicaily polymerizable compound include an epoxy compound, a vinyl ether compound, and an oxetane compound.

Examples of the epoxy compound include: an alicyclic epoxy resin such as 3,4-epoxycyclohexylmethyl-3′,4′-epoxycyclohexane carboxylate, bis(3,4-epoxycyclohexylmethyl) adipate, vinylcyclohexene monoepoxide, ε-caprolactone modified 3,4-epoxycyclohexylmethyl 3′,4′-epoxycyclohexane carboxylate, 1-methyl-4-(2-methyloxiranyl)-7-oxabicyclo [4,1,0] heptane, 2-(3,4-epoxycyclohexyl-5,5-spiro-3,4-epoxy) cyclohexanone-meta-dioxane, or bis(2,3-epoxycyclopentyl) ether; an aliphatic epoxy compound such as a polyglycidyl ether of polyether polyol, obtained by adding one or more alkylene oxides (for example, ethylene oxide and propylene oxide) to an aliphatic polyhydric alcohol such as a diglycidyl ether of 1,4-butanediol, a diglycidyl ether of 1,6-hexanediol, a triglycidyl ether of glycerin, a triglycidyl ether of trimethylolpropane, a diglycidyl ether of polyethylene glycol, a diglycidyl ether of propylene glycol, ethylene glycol, propylene glycol, or glycerin; and an aromatic epoxy compound including a di- or polyglycidyl ether of bisphenol A or an alkylene oxide adduct thereof, a di- or polyglycidyl ether of hydrogenated bisphenol A or an alkylene oxide adduct thereof, and a novolac epoxy resin.

Examples of the vinyl ether compound include: a monovinyl ether compound such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-o-propylene carbonate, dodecyl vinyl ether, diethylene glycol monovinyl ether, or octadecyl vinyl ether; and a di- or tri-vinyl ether compound such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, or trimethylolpropane trivinyl ether.

Examples of the oxetane compound include 3-hydroxymethyl-3-methyloxetane, 3-hydroxymethyl-3-ethyl oxetane, 3-hydroxy methyl-3-propyl oxetane, 3-hydroxymethyl-3-normalbutyl oxetane, 3-hydroxy methyl-3-phenyloxetane, 3-hydroxymethyl-3-benzyloxetane, 3-hydroxyethyl-3-methyloxetane, 3-hydroxyethyl-3-ethyloxetane, 3-hydroxyethyl-3-propyloxetane, 3-hydroxyethyl-3-phenyloxetane, 3-hydroxypropyl-3-methyloxetane, 3-hydroxypropyl-3-ethyloxetane, 3-hydroxypropyl-3-propyloxetane, 3-hydroxypropyl-3-phenyloxetane, 3-hydroxybutyl-3-methyloxetane, 1,4 bis{[(3-ethyl-3-oxetanyl) methoxy] methyl} benzene, 3-ethyl-3-(2-ethylhexyloxymethyl) oxetane, and di[1-ethyl (3-oxetanyl)] methyl ether.

The active ray polymerization initiator can initiate polymerization of an active ray polymerizable compound by irradiation with an active ray. The active ray polymerization initiator is preferably a radical polymerization initiator, but may further contain a cationic polymerization initiator. Only one kind or two or more kinds of the active ray polymerization initiators may be contained in the inkjet ink.

The radical polymerization initiator includes an intramolecular bond cleavage type radical polymerization initiator and an intramolecular hydrogen abstraction type radical polymerization initiator.

Examples of the intramolecular bond cleavage type radical polymerization initiator include: an acetophenone-based initiator including diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy) phenyl-(2-hydroxy-2-propyl) ketone, 1-hydroxycyclohexyl-phenyl ketone, 2-methyl-2-morpholino (4-methylthiophenyl) propan-1-one, and 2-benzyl-2-dimethylamino-1-(4-morpholinophenyl)-butanone; a benzoin including benzoin, benzoin methyl ether, and benzoin isopropyl ether; an acylphosphine oxide-based initiator including 2,4,6-trimethylbenzoin diphenylphosphine oxide; benzyl; and a methylphenyl glyoxy ester.

Examples of the intramolecular hydrogen abstraction type radical polymerization initiator include: a benzophenone-based initiator including benzophenon methyl o-benzoylbenzoate-1-phenylbenzophenone, 4,4′-dichlorobenzophenone, hydroxybenzophenone, 4-benzoyl-4′-methyl-diphenylsulfide, acrylated benzophenone, 3,3′,4,4′-tetra(t-butylperoxycarbonyl) benzophenone, and 3,3′-dimethyl-4-methoxybenzophenone; a thioxanthone-based initiator including 2-isopropylthioxanthone, 2,4-dimethylthioxanthone, 2,4-diethylthioxanthone, and 2,4-dichlorothioxanthone; an aminobenzophenone-based initiator including Michler's ketone and 4,4′-diethylaminobenzophenone; 10-butyl-2-chloroacridone; 2-ethylanthraquinone; 9,10-phenanthrenequinone; and camphorquinone.

Examples of the cationic polymerization initiator include a photoacid generator. Examples of the photoacid generator include a sulfonate that generates a sulfonic acid, a halide that generates a hydrogen halide with light, and an iron allene complex, such as a B(C₆F₅)₄⁻ salt, a PF₆⁻ salt, an AsF₆⁻ salt, a SbF₆⁻ salt, or a CF₃SO₃⁻ salt of an aromatic onium compound including diazonium, ammonium, iodonium, sulfonium, and phosphonium.

The inkjet ink may further contain other components including a coloring material, a dispersant, a polymerization inhibitor, a surfactant, and a wax. Only one kind or two or more kinds of these components may be contained in the inkjet ink.

The coloring material includes a dye and a pigment. The coloring material is preferably a pigment from a viewpoint of obtaining an image with good weather resistance. The pigment can be selected, for example, from a yellow pigment, a red or magenta pigment, a blue or cyan pigment, and a black pigment according to the color or the like of an image to be formed.

Examples of the yellow pigment include C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 180, and C.I. Pigment Yellow 185.

Examples of the red or magenta pigment include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48;1, C.I. Pigment Red 53;1, C.I. Pigment Red 57;1, C.I. Pigment Red 122, C.I. Pigment Red 123, C.I. Pigment Red 139, C.I. Pigment Red 144, C.I. Pigment Red 149, C.I. Pigment Red 150, C.I. Pigment Red 166, C.I. Pigment Red 177, C.I. Pigment Red 178, C.I. Pigment Red 184, C.I. Pigment Red 222, and C.I. Pigment Red 269.

Examples of the blue or cyan pigment include C.I. Pigment Blue 15. C.I. Pigment Blue 15;2, C.I. Pigment Blue 15;3, C.I. Pigment Blue 15;4, C.I. Pigment Blue 16, C.I. Pigment Blue 60, C.I. Pigment Blue 62, and C.I. Pigment Blue 66.

Examples of the black pigment include carbon black such as furnace black, channel black, acetylene black, thermal black, or lamp black, magnetite, and ferrite.

Examples of the dispersant include a hydroxy group-containing carboxy late, a salt of a long chain polyaminoamide and a high molecular weight acid ester, a salt of a high molecular weight polycarboxylic acid, a salt of a long chain polyaminoamide and a polar acid ester, a high molecular weight unsaturated acid ester, a high molecular copolymer, a modified polyurethane, a modified polyacrylate, a polyether ester type anion activator, a naphthalene sulfonic acid formalin condensate salt, an aromatic sulfonic acid formalin condensate salt, a polyoxyethylene alkyl phosphate, polyoxyethylene nonyl phenyl ether, and stearyl amine acetate.

Examples of the polymerization inhibitor include (alkyl) phenol, hydroquinone, catechol, resorcin, p-methoxyphenol, t-butylcatechol, t-butylhydroquinone, pyrogaliol, 1,1-pierylhydrazyl, phenothiazine, p-beuzoquinone, nitrosobenzene, 2,5-di-t-butyl-p-benzoquinone, dithiobenzoyl disulfide, picric acid, cupferron, aluminum N-nitrosophenylhydroxylamine, tri-p-nitrophenylmethyl, N-(3-oxyanilino-1,3-dimethylbutylidene) aniline oxide, dibutyl cresol, cyclohexanone oxime cresol, guaiacol, o-isopropyl phenol, butyral doxime, methylethyl ketoxime, and cyclohexanone oxime.

Examples of the surfactant include an anionic surfactant such as a dialkyl sulfosuccinate, an alkylnaphthalene sulfonate, or a fatty acid salt; a nonionic surfactant such as a polyoxyethylene alkyl ether, a polyoxyethylene alkyl allyl ether, an acetylene glycol, or a polyoxy ethylene-polyoxypropylene block copolymer; a cationic surfactant such as an alkylamine salt or a quaternary ammonium salt; and a silicone or fluorine surfactant.

The wax enhances an ink pinning property and makes formation of a higher-definition image possible. Only one kind or two or more kinds of the waxes may be contained in the inkjet ink. Examples of the wax include: an aliphatic ketone compound; an aliphatic ester compound; a petroleum-based wax such as a paraffin wax, a microcrystalline wax, or petrolactam; a plant-based wax such as a candelilla wax, a carnauba wax, a rice wax, a wood wax, a jojoba oil, a jojoba solid wax, or a jojoba ester; an animal-based wax such as a beeswax, lanolin, or spermaceti; a mineral-based wax such as a montan wax or a hydrogenated wax; a cured castor oil or a cured castor oil derivative; a modified wax such as a montan wax derivative, a paraffin wax derivative, a microcrystalline wax derivative, or a polyethylene wax derivative; a higher fatty acid such as behenic acid, arachidic acid, stearic acid, palmitic acid, myristic acid, lauric acid, oleic acid, or erucic acid; a higher alcohol such as stearyl alcohol or behenyl alcohol; a hydroxystearic acid such as 12-hydroxystearic acid; a 12-hydroxystearic acid derivative; a fatty acid amide such as a lauric acid amide, a stearic acid amide, a behenic acid amide, an oleic acid amide, an erucic acid amide, a ricinoleic acid amide, or a 12-hydroxystearic acid amide (for example, Nikka Amide series manufactured by Nippon Kasei Chemical Co., Ltd., ITOWAX series manufactured by Itoh Oil Chemicals Co., Ltd., and FATTYAMID series manufactured by Kao Corporation); an N-substituted fatly acid amide such as an N-stearyl stearic acid amide or an N-oleyl palmitic acid amide; a special fatty acid amide such as N,N′-ethylenebisstearylamide, N,N′-ethylenebis-12-hydroxystearylamide, or N,N′-xylylenebisstearylamide; a higher amine such as dodecylamine, tetradecylamine, or octadecylamine; and a synthetic wax such as a polyethylene wax or an α-olefin maleic anhydride copolymer wax (UNILIN series manufactured by Baker-Petrolite and the like).

Among these compounds, the wax is preferably an aliphatic ketone compound, an aliphatic ester compound, a higher fatty acid, a higher alcohol, or a fatty acid amide.

[Cleaning Method]

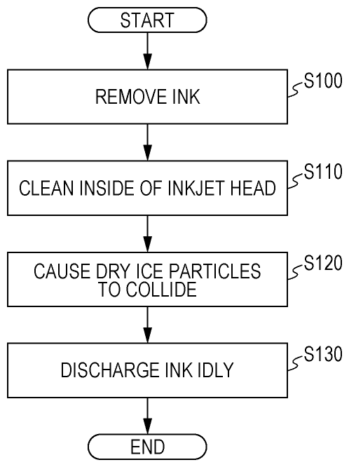

FIG. 1 is a flowchart of a method for cleaning an ink discharger of an inkjet head according to an embodiment of the present invention.

As illustrated in FIG. 1, the method for cleaning an ink discharger of an inkjet head according to an embodiment of the present invention includes a step of causing dry ice particles to collide with an ink discharge port (S120).

Note that as illustrated in FIG. 1, in the present embodiment, in addition to the step of causing dry ice particles to collide, a step of removing ink from the inside of an inkjet head (S100), a step of cleaning the inside of the inkjet head (S110), and a step of discharging ink idly from an ink discharge port (S130) may be included.

<Step of Removing Ink (S100)>

In this step, ink remaining inside the inkjet head is removed.

Specifically, gas is introduced into the inkjet head, and ink is pushed out from the ink discharge port.

The kind of the gas is not particularly limited, and examples of the gas include air, oxygen, and nitrogen. Air is preferably used from a viewpoint of easily introducing gas into the inkjet head without using a cylinder or the like.

A flow rate of the gas is preferably 0.1 L/min or more and 1 L/min or less. When the flow rate is 0.1 L/min or more, ink inside the inkjet head can be pushed out. When the flow rate is 1 L/min or less, damage to the inkjet head due to an increase in pressure inside the inkjet head can be prevented. Therefore, the internal pressure inside the inkjet head at the time of gas introduction is preferably 0.1 MPa or more and 0.8 MPa or less.

This step may be ended when ink is no longer pushed out from the ink discharge port. At this time, ink that has not be completely pushed out by the gas may remain.

<Step of Cleaning Inside of Inkjet Head (S110)>

In this step, the inside of the inkjet head is then cleaned, and gas is introduced again after cleaning to remove a cleaning liquid remaining in the inkjet head.

Examples of a method for cleaning the inside of the inkjet head include a method for introducing a cleaning liquid into the inkjet head and a method for introducing a cleaning liquid containing air bubbles.

The gas introduced at the time of removing the cleaning liquid may be similar to the gas introduced at the time of removing ink, and therefore description thereof will be omitted.

<Step of Causing Dry Ice Particles to Collide (S120)>

In this step, dry ice particles are caused to collide with the ink discharge port of the inkjet head.

Specifically, dry ice particles are jetted to the ink discharge port and caused to collide with the ink discharge port using compressed air of a compressor or the like. When dry rce particles collide with an object to be cleaned, the object to be cleaned is rapidly cooled by heat shrinkage and easily generates a crack. When dry ice particles entering the crack or dry ice particles entering a gap between a substrate and the object to be cleaned are vaporized, the volume of the dry ice particles rapidly expands, and therefore the object to be cleaned is peeled off. As described above, by causing dry ice particles to collide within a certain jetting pressure range in order to peel off an attached matter by vaporization of the dry ice particles, cleaning can be performed while damage to a surface of the substrate is suppressed.

A dry ice cleaner used for causing dry ice particles to collide with the ink discharger is not particularly limited as long as the effect of the present invention is exhibited. Specific examples of the dry ice cleaner include a two-hose type, a one-hose type, and a dry ice powder type.

The two-hose type dry ice cleaner is a cleaner in which a cleaner body is connected to a gun with two hoses. One of the two hoses is a main hose, and the other is a dry ice hose. Compressed air flows through the main hose, and dry ice particles filled in the cleaner body are sucked into the dry ice hose. The air flowing through the main hose and the dry ice particles flowing through the dry ice hose are mixed with each other at a nozzle. Furthermore, the dry ice particles are accelerated rapidly in the nozzle and sprayed onto an object.

In the one-hose type dry ice cleaner, a cleaner body is connected to a gun with one hose. A predetermined amount of air and a predetermined amount of dry ice particles are mixed with each other inside the cleaner body in advance and sent to the hose. The hose is connected to the gun, and the air and the dry ice particles pass through the gun and reach a nozzle in a state where the air and the dry ice particles are accelerated to a certain degree. Furthermore, the air and the dry ice particles are accelerated inside the nozzle to the speed of sound and sprayed onto an object.

Examples of the dry ice powder type dry ice cleaner include a cleaner that pulverizes dry ice pellets into an appropriate size in the cleaner or inside a nozzle, mixes the pulverized dry ice pellets with air, and sprays the resulting mixture, and a cleaner that connects a tank or the like storing liquefied carbon dioxide to a gun, and sprays powdery dry ice particles mixed with air from a nozzle.

It is preferable to use a one-hose type dry ice cleaner from a viewpoint that the consumption amount of dry ice can be controlled, and it is preferable to use a dry ice powder type dry ice cleaner from a viewpoint that dry ice particles having a small average particle size can be jetted.

In a case of the dry ice powder type cleaner using liquefied carbon dioxide, a jetting pressure of dry ice particles is determined by adjusting the flow rate of liquefied carbon dioxide and the flow rate of air. The flow rate of liquefied carbon dioxide is preferably 0.1 L/min or more and 1.0 L/min or less, and more preferably 0.2 L/min or more and 0.4 L/min or less. The flow rate of air is preferably 0.05 L/min or more and 1.0 L/min or less, and more preferably 0.1 L/min or more and 0.3 L/min or less. By adjusting the flow rate of liquefied carbon dioxide and the flow rate of air within the above ranges, the jetting pressure of dry ice particles can be appropriately set while the amount of dry ice particles to be jetted is increased.

The jetting pressure of dry ice particles is preferably 0.1 MPa or more and 10 MPa or less, more preferably 0.5 MPa or more and 5 MPa or less, and still more preferably 1 MPa or more and 2 MPa or less. When the jetting pressure is 0.1 MPa or more, cleaning efficiency can be improved. When the jetting pressure is 10 MPa or less, peeling of the liquid-repellent film of the inkjet head due to damage and damage to the ink discharger can be suppressed.

The average particle size of dry ice particles in the present embodiment can be measured by photographing the dry ice particles jetted from a dry ice jetting nozzle with a CCD camera (CS8320B manufactured by Tokyo Electronics Industry Co., Ltd) and analyzing an image at the moment when the dry ice particles are jetted from the nozzle using image processing software (Image-Pro Plus manufactured Planetron Co., Ltd.).

The average particle size of dry ice particles is preferably smaller than the diameter of the ink discharge port from a viewpoint of allowing the dry ice particles to enter the ink discharge port of the inkjet head and promoting peeling of an attached matter inside the ink discharge port. Specifically, the average particle size is preferably 1 μm or more and 30 μm or less, more preferably 5 μm or more and 25 μm or less, and still more preferably 10 μm or more and 20 μm or less.

As for an angle at which dry ice particles are jetted, an angle formed by a plane where the ink discharge ports are arranged and a direction in which the dry ice particles are jetted (hereinafter, referred to as a jetting angle) is preferably 30° or more and 60° or less, and more preferably 30° or more and 45° or less. The above angle refers to an angle when an angle formed by a plane where the ink discharge ports are arranged is parallel to a direction in which dry ice particles are jetted is 0°. When the jetting angle is within the above range, dry ice particles can enter a gap between an attached matter of the ink discharger and the substrate, and the attached matter is peeled off.

When a plurality of ink discharge ports is cleaned, dry ice particles may be jetted while a dry ice jetting nozzle is moved. At this time, the moving speed of the dry ice jetting nozzle is preferably 1 mm/s or more and 5 mm/s or less. When the moving speed of the dry ice jetting nozzle is within the above range, cleaning efficiency can be improved while damage to the ink discharger is suppressed. Note that the dry ice jetting nozzle may move one way or reciprocate from one end to the other end of a plane where the ink discharge ports are arranged. At this time, a single dry ice jetting nozzle may be used, or a plurality of dry ice jetting nozzles may be used.

A distance between a tip of the dry ice jetting nozzle and the plane where the ink discharge ports are arranged is preferably 5 mm or more and 10 mm or less. When the distance is 5 mm or more, damage to the ink discharger can be suppressed. When the distance is 10 mm or more, cleaning efficiency is decreased.

<Step of Discharging Ink Idly (S130)>

In this step, ink is filled in the inkjet head, and the ink is discharged onto a recording medium.

After the ink discharger of the inkjet head is cleaned, dry ice particles remaining in the ink discharge port are preferably removed. By discharging ink idly after cleaning, the remaining dry ice particles can be removed. Note that ink may be discharged idly after the inkjet head is moved above an ink collecting container.

Note that the cleaning method in the present embodiment may further include a step of detaching the inkjet head from an image forming apparatus before these steps, and may further include a step of attaching the inkjet head to the image forming apparatus alter this step. By detaching the inkjet head from the image forming apparatus and causing dry ice particles to collide with the inkjet head, it is possible to suppress unintended damage to other components of the image forming apparatus due to collision of the dry ice particles with the other components.

Note that the above embodiment merely illustrates an example for carrying out the present invention, and the technical scope of the present invention should not be limitedly interpreted thereby. That is, the present invention can be carried out in various forms without departing from the gist or the main features thereof.

For example, in the above embodiment, cleaning of the discharger of the inkjet head that discharges an active ray curable ink has been described, but a discharger of an inkjet head that discharges an aqueous ink, a solvent-based ink, and the like may be similarly cleaned.

In the above embodiment, dry ice particles are caused to collide alter ink inside the inkjet head is removed, but dry ice particles may be caused to collide without removing ink.

In the above embodiment, the liquid-repellent film is formed on the surface of the nozzle plate, but the liquid-repellent film does not have to be formed.

### Examples

Hereinafter, the present invention will be described in more detail with reference to Example, but the description does not limit the scope of the present invention.

The inkjet head used in the present Example was used until an inkjet ink replacement sign appeared.

<Experiment 1>

This experiment was performed using a dry ice cleaner (tabletop type QuickSnow, manufactured by Air Water Inc., Ltd.) connected to a liquefied carbon dioxide cylinder. The dry ice cleaner was disposed such that a jetting angle was 45° with respect to an inkjet head co (discharge port diameter: 40 μm) having a discharge port onto which a polyimide film having a fluorine-based resin liquid-repellent film formed thereon was stuck. At this time, a distance between a tip of the ink discharge port and a tip of a dry ice jetting nozzle 1 (nozzle diameter: 1 mm) was 5 mm. Subsequently, the flow rate of liquefied carbon dioxide and the flow rate of air were adjusted such that a jetting pressure was 0.1 MPa, and then dry ice particles having an average particle size of 10 am were jetted toward the ink discharge port. At this time, the dry ice particles were jetted while the dry ice jetting nozzle was reciprocated twice from one end side to the other end side in a direction in which the ink discharge ports were arranged at a speed of 2 mm/s. Note that a pressure gauge indicating the jetting pressure was disposed in a pipe through which the mixture was caused to flow to the dry ice jetting nozzle after the liquefied carbon dioxide and the air were mixed, and the flow rate of the liquefied carbon dioxide and the flow rate of the air were adjusted based on a value indicated by the pressure gauge.

<Experiments 2 to 11>

An experiment was performed in a similar manner to the above except that the discharge port diameter of the inkjet head, the dry ice particle size, the jetting pressure, and the jetting angle were changed as illustrated in Table 1 in the above <Experiment 1>. Note that in Experiments 3, 8, and 9, the discharge port diameter of the inkjet head was changed by changing the inkjet head α in the above <Experiment 1> to an inkjet head β (discharge port diameter: 30 μm). In Experiments 3 to 5, 8, and 9, the dry ice particle size was changed by changing the dry ice jetting nozzle 1 to a dry ice jetting nozzle 2 (nozzle diameter: 0.5 nm).

<Experiment 12>

An air jetting nozzle was disposed so as to jet air at an angle of 90° with respect to a plane where discharge ports of the inkjet head α were arranged. At this time, a distance between a tip of the ink discharge port and a tip of the air jetting nozzle was 5 mm. Subsequently, air was jetted from the air jetting nozzle toward the ink discharge port at a jetting pressure of 0.1 MPa. At this time, air was jetted while the air jetting nozzle was reciprocated twice from one end side to the other end side in a direction in which the ink discharge ports were arranged at a speed of 2 mm/s.

<Experiment 13>

Ink remaining in the ink discharger was manually wiped off using a polyester ink absorber (nonwoven fabric).

<Measurement of Dry Ice Particle Size>

In the above experiment, dry ice particles jetted from the dry ice jetting nozzle were photographed with a CCD camera (CS8320B manufactured by Tokyo Electronics Industry Co., Ltd.). An image at the moment when the dry ice particles were jetted from the nozzle was analyzed using image processing software (Image-Pro Plus Manufactured Planetron Co., Ltd.), and the particle sizes of the dry ice particles were measured.

<Measurement of Droplet Contact Angle with Respect to Nozzle Surface>

With respect to a film surface inside the discharge port of the cleaned inkjet head α, a droplet contact angle was reassured using a portable contact angle meter (PCA-11), manufactured by Kyowa Interface Science Co., Ltd.) and evaluated according to the following criteria. At this time, the liquid used for the measurement was pure water. Measurement and evaluation were also performed by a similar method for each of the cleaned inkjet head β and a cleaned inkjet head γ.

◯: The droplet contact angle is larger than 70° (The ink discharge port is less damaged, and there is no problem in use)

x: The droplet contact angle is 70° or less (The ink discharge port is significantly damaged, affecting discharge stability)

<Preparation of Yellow UV Ink>

In a stainless beaker, 9.0 parts by mass of a pigment dispersant (Ajisper PB824, manufactured by Ajinomoto Fine-Techno Co., Inc., “Ajisper” is a registered trademark of Ajinomoto Co., Inc.), 70.0 parts by mass of an active ray polymerizable compound (tripropylene glycol diacrylate), and 0.02 parts by mass a polymerization inhibitor (Irgastab UV10, manufactured by BASF, “Irgastab” is a registered trademark of BASF) were put, and heated and stirred for one hour while being heated with a hot plate at 65° C.

The mixed liquid was cooled to room temperature, and then 21.0 parts by mass of a yellow pigment Pigment Yellow 185 was added thereto. The mixed liquid was put in a glass bottle together with 200 g of zirconia beads each having a diameter of 0.5 mm. The glass bottle was tightly sealed, and the mixture was dispersed for eight hours with a paint shaker. Thereafter, the zirconia beads were removed to prepare a pigment dispersion.

In a stainless beaker, 5.0% by mass of a gelling agent “Lunac BA” (behenic acid, manufactured by Kao Corporation, “Lunac” is a registered trademark of Kao Corporation), 29.9% by mass of an active ray polymerizable compound (polyethylene glycol #400 diacrylate), 23.0% by mass of 6EO modified trimethylolpropane triacrylate, 15.0% by mass of 4EO modified pentaerythritol tetraacrylate, 8.0% by mass of a polymerization initiator “IRGACURE 819” (manufactured by BASF, “IRGACURE” is a registered trademark of BASF), 0.1% by mass of a surfactant “KF-352” (manufactured by Shin-Etsu Chemical Co., Ltd.), and 19.0% by mass of a pigment dispersion were put, and stirred for one hour while being heated with a hot plate at 80° C. The obtained solution was filtered through a Teflon (registered trademark) 3 μm membrane filter manufactured by ADVANTEC Corporation while being heated to obtain a yellow UV ink.

<Evaluation of Ink Discharge Stability>

Using a cleaned inkjet head t, the yellow UV ink was continuously discharged under conditions of a droplet amount of 3.5 pL, a liquid dropping speed of 7 m/s, an ejection speed of 40 kHz, and a printing ratio of 100%. Thereafter, the number of nozzles (defective nozzles) that did not eject ink was counted one minute, five minutes, and 10 minutes after start of discharge, and the total number was evaluated according to the following criteria.

◯: The number of defective nozzles is 0.

Δ: The number of defective nozzles is 2 or more and less than 10.

x: The number of defective nozzles is 50 or more.

<Evaluation of Landing Position Accuracy>

The cleaned inkjet head α was set in an image forming apparatus 200, and an inkjet head unit was set on a 1 μm accuracy conveyance stage such that an image could be formed by a one-pass method. Onto the conveyance stage, a polyethylene film cut into a sheet shape (Taiko Polyester Film FE #50-FE2001, manufactured by Futamura Chemical Co., Ltd.) was fixed. An ink tank 150 was filled with the yellow UV ink. The yellow UV ink was discharged from an inkjet head to print a plurality of thin lines each having a thickness of 0.1 mm, and cured with a UV lamp. Evaluation was performed according to the following criteria. Measurement and evaluation were also performed by a similar method for each of the cleaned inkjet head 3 and a cleaned inkjet head γ.

◯: The thickness of a thin line and an interval between adjacent thin lines do not vary, and an equivalent image is repeatedly obtained.

x: The thickness of a thin line and an interval between adjacent thin lines vary, and an image is not printed correctly.

TABLE 1

| | Conditions | | | | | | |
|---|---|---|---|---|---|---|---|
| | Inkjet | Dry ice | | | | | |
| | discharge | average | | | Results | | |
| | port | particle | Jetting | | | | Landing |
| | diameter | size | pressure | Jetting | Contact | Discharge | position |
| | [μm] | [μm] | [MPa] | angle [°] | angle [°] | stability | accuracy |
| Experiment 1 | 40 | 10 | 0.10 | 45 | 85 (◯) | ◯ | ◯ |
| Experiment 2 | 40 | 10 | 10.00 | 45 | 83 (◯) | ◯ | ◯ |
| Experiment 3 | 30 | 5 | 0.10 | 45 | 88 (◯) | ◯ | ◯ |
| Experiment 4 | 40 | 5 | 0.10 | 60 | 84 (◯) | ◯ | ◯ |
| Experiment 5 | 40 | 5 | 0.10 | 30 | 84 (◯) | ◯ | ◯ |
| Experiment 6 | 40 | 10 | 0.07 | 45 | 87 (◯) | Δ | Δ |
| Experiment 7 | 40 | 10 | 12.00 | 45 | 55 (X) | Δ | Δ |
| Experiment 8 | 30 | 5 | 0.10 | 90 | 86 (◯) | Δ | Δ |
| Experiment 9 | 30 | 5 | 0.10 | 25 | 85 (◯) | Δ | Δ |
| Experiment 10 | 40 | 10 | 1.00 | 45 | 91 (⊙) | ⊙ | ⊙ |
| Experiment 11 | 40 | 10 | 2.00 | 45 | 90 (⊙) | ⊙ | ⊙ |
| Experiment 12 | 40 | — | 0.10 | 45 | 85 (◯) | X | X |
| Experiment 13 | 40 | — | — | — | 90 (⊙) | X | X |

### RESULTS AND DISCUSSION

In Experiments 1 to 11, the discharge stability and the landing position accuracy were better than those in Experiments 12 and 13. This is considered to be because dry ice particles are vaporized and expanded by causing the dry ice particles to collide with the ink discharge port of the inkjet head, and an ink residue is peeled oil.

In particular, in Experiments 1 to 5, 10, and 11, the jetting pressure was 0.1 MPa or more and 10 MPa or less and the jetting angle was 30° or more and 60° or less, and therefore the discharge stability and the landing position accuracy were better than those in Experiments 6 to 9. In addition, since the jetting pressure was 0.1 MPa or more anti 10 MPa or less, damage to the ink discharge port could be suppressed.

Meanwhile, in Experiments 12 and 13, ink remaining is the ink discharge port could not be completely removed, and therefore the discharge stability and the landing position accuracy were not improved.

The cleaning method according to an embodiment of the present invention makes it possible to suppress nozzle defectiveness and improve the landing position accuracy of ink droplets in the cleaned inkjet head. Therefore, it is expected that the present invention will make image formation by an inkjet method easier and contribute to advancement and popularization of technology in this field.

Although embodiments of the present invention have been described and illustrated in detail, the disclosed embodiments are made for purposes of illustration and example only and not limitation. The scope of the present invention should be interpreted by terms of the appended claims.

What is claimed is:

1. A method for cleaning an ink discharger of an inkjet head, the method comprising
causing dry ice particles to collide with an ink discharge port of an inkjet head.

2. The method for cleaning an ink discharger of an inkjet head according to claim 1, wherein
an average particle size of the dry ice particles is
smaller than a diameter of the ink discharge port.

3. The method for cleaning an ink discharger of an inkjet head according to claim 1, wherein
in causing the dry ice particles to collide,
the dry ice particles are caused to collide with the ink discharge port at a jetting pressure of 0.1 MPa or more and 10 MPa or less.

4. The method for cleaning an ink discharger of an inkjet head according to claim 1, wherein
in causing the dry ice particles to collide,
the dry ice particles are jetted such that
an angle formed by a plane where the ink discharge ports are arranged and a direction in which the dry ice particles are jetted is 30° or more and 60° or less, and
the dry ice particles are caused to collide with the ink discharge ports.

5. The method for cleaning an ink discharger of an inkjet head according to claim 1, the method comprising
discharging ink idly from the ink discharge port
after causing the dry ice particles to collide.

6. The method for cleaning an ink discharger of an inkjet head according to claim 1, wherein
the dry ice particles are caused to collide
after ink is removed from an inside of the inkjet head.
